(19) United States
(12) Patent Application Publication
(10) Pub. No.: US 2022/0035231 A1
(43) Pub. Date: Feb. 3, 2022

(54) PROJECTION APPARATUS

(71) Applicant: IVIEW DISPLAYS (SHENZHEN) COMPANY LTD., Shenzhen (CN)

(72) Inventors: Steve Yeung, Shenzhen (CN); Zhiqiang Gao, Shenzhen (CN); Qiongsheng Xu, Shenzhen (CN); Wenxiang Li, Shenzhen (CN); Mingnei Ding, Shenzhen (CN); Guoming Lu, Shenzhen (CN)

(21) Appl. No.: 17/504,462

(22) Filed: Oct. 18, 2021

Related U.S. Application Data
(63) Continuation of application No. PCT/CN2019/103834, filed on Aug. 30, 2019.

(30) Foreign Application Priority Data
Aug. 9, 2019 (CN) 201910734182.8

(51) Int. Cl. G03B 21/28; G03B 21/14

(52) U.S. Cl. CPC G03B 21/28; G03B 21/145

(57) ABSTRACT

The embodiments of the present disclosure, relating the technical field of projection display, provide a projection apparatus. A projection apparatus includes a projection unit, configured to project a projection image; a support frame, one end of the support frame being fixed to the projection unit; a regulation unit, suspended at the other end of the support frame; and a reflection unit, fixed to the regulation unit, and configured to reflect the projection image. A reflection direction of the reflection unit is regulated by regulating a rotation angle of the reflection unit, such that the reflection unit reflects the projection image to a target projection position.

### CROSS-REFERENCE TO RELATED APPLICATIONS

This application is a continuation-application of International (PCT) Patent Application No. PCT/CN2019/103834, filed on Aug. 30, 2019, which claims priority to Chinese Patent Application No. 201910734182.8, filed with the National Intellectual Property Administration of China on Aug. 9, 2019, and entitled “PROJECTION APPARATUS”, the entire contents of which are incorporated herein by reference.

### TECHNICAL FIELD

The present disclosure relates to the technical field of projection display, and in particular, relates to a projection apparatus.

### BACKGROUND

With the rapid development of the semiconductor display technologies, various portable electronic devices are being continuously designed and manufactured. Wide application of the portable electronic devices pushes requirements of the users on display devices to develop towards miniaturization, high resolution, and movability. Under such intense demands, projection technologies have got rapid development, and varieties of small-size and high-performance portable projectors have been placed into the market. At present, various application scenarios need motion projection, such as families, large-scale stages, and the like. A projection device needs to multi-directionally project images according to a user instruction, and needs to be synchronized with projection content, such that an immersive experience is created by combining motion with content.

However, in most of the existing motion projection schemes, a projection optical engine is directly moved, and since the projection optical engine involves various components including a digital micromirror wafer, a heat sink, a light source, and the like, large power is required for moving the projection optical engine. In addition, control of the projection optical engine is complicated, and thus a fault is easily caused.

### SUMMARY

The present disclosure is to provide a projection apparatus that is capable of conveniently regulating a projection direction.

In a first aspect, embodiments of the present disclosure provide a projection apparatus. The apparatus includes:

a projection unit, configured to project a projection image;

a support frame, one end of the support frame being fixed to the projection unit;

a regulation unit, suspended at the other end of the support frame, and configured to regulate a rotation angle; and

a reflection unit, fixed to the regulation unit, and configured to reflect the projection image, wherein the regulation unit is configured to regulate a reflection direction of the reflection unit.

In some embodiments, the regulation unit includes:

a first rotation assembly, fixed to the other end of the support frame; and

a second rotation assembly, fixed to the first rotation assembly, wherein the reflection unit is fixed to the second rotation assembly, the first rotation assembly is configured to drive the second rotation assembly to rotate in a first direction, and the second rotation assembly is configured to drive the reflection unit to rotate in a second direction, the first direction being different from the second direction.

In some embodiments, the first rotation assembly includes: a driven gear, a driving gear, and a first motor;

wherein the driven gear is fixed to the second rotation assembly, the first motor is fixed to the support frame, a rotation shaft of the first motor is fixed to the driving gear, and the driving gear is in mesh with the driven gear.

In some embodiments, the second rotation assembly includes: a second motor and a first support arm;

wherein the first support arm is rotatably connected to the support frame, the driven gear is fixed to the first support arm, a housing of the second motor is fixed to the reflection unit, and a rotation shaft of the second motor is fixed to the first support arm.

In some embodiments, the second rotation assembly further includes: a second support arm;

wherein one end of the second support arm is fixed to the first support arm, and the other end of the second support arm is rotatably connected to the housing of the second motor.

In some embodiments, the second rotation assembly includes: a motor fixing frame;

wherein the reflection unit is fixed to the motor fixing frame, the second motor is fixed inside the motor fixing frame, the rotation shaft of the second motor is extended out of the motor fixing frame, and the motor fixing frame is rotatably connected to the other end of the second support arm.

In some embodiments, the first motor and the second motor are both a step motor.

In some embodiments, the projection apparatus further includes:

a first position sensor, fixed to the first motor; and

a second position sensor, fixed to the first support arm.

In some embodiments, the reflection unit is a reflection mirror.

In some embodiments, the projection apparatus further includes: a microcontroller unit;

wherein the microcontroller unit is connected to the regulation unit, and is configured to control the regulation unit to rotate.

Compared with the related art, the embodiments of the present disclosure achieve the following beneficial effects: The embodiments of the present disclosure provide a projection apparatus. The projection apparatus includes: a projection unit, configured to project a projection image; a support frame, one end of the support frame being fixed to the projection unit; a regulation unit, suspended at the other end of the support frame; and a reflection unit, fixed to the regulation unit, and configured to reflect the projection image. A reflection direction of the reflection unit is regulated by regulating a rotation angle of the reflection unit, such that the reflection unit reflects the projection image to a target projection position.

### BRIEF DESCRIPTION OF THE DRAWINGS

One or more embodiments are illustrated by way of example, and not by limitation, in the figures of the accompanying drawings, wherein modules and steps having the same reference numeral designations represent like modules and steps throughout. The drawings are not to scale, unless otherwise disclosed.

FIG. 1 is a schematic structural view of a projection apparatus according to an embodiment of the present disclosure;

FIG. 2 is a top view of the projection apparatus in FIG. 1; and

FIG. 3 is an exploded view of a regulation unit and a reflection unit in the projection apparatus in FIG. 1.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure. Further, the terms “first,” “second,” and “third” used in this text do not limit data and execution sequences, and are intended to distinguish identical items or similar items having substantially the same functions and effects.

It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. As used herein, the terms “vertical,” “horizontal,” “left,” “right,” and similar expressions are for illustration purposes. For ease of definition of the connection structure, the positions of the components are defined using an emergent direction of a projection unit for projecting a projection image as a reference.

Unless the context clearly requires otherwise, throughout the specification and the claims, technical and scientific terms used herein denote the meaning as commonly understood by a person skilled in the art. Additionally, the terms used in the specification of the present disclosure are merely for description the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

Specifically, hereinafter, the embodiments of the present disclosure are further illustrated with reference to the accompanying drawings.

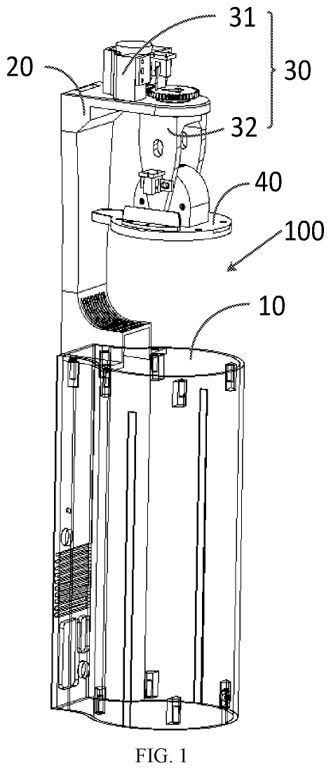

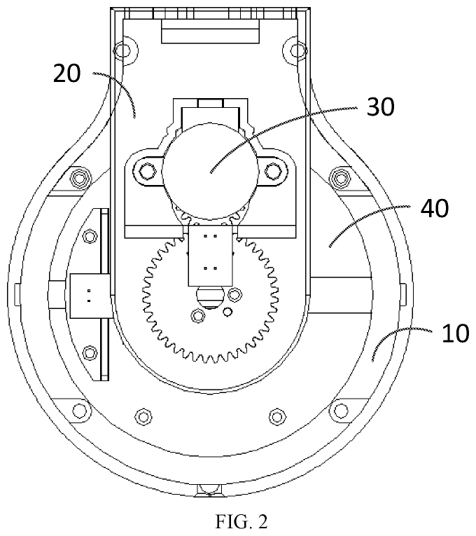

An embodiment of the present disclosure provides a projection apparatus. Referring to FIG. 1 and FIG. 2, a schematic structural view and a top view of the projection apparatus 100 according to an embodiment of the present disclosure are illustrated. The projection apparatus 100 includes a projection unit 10, a support frame 20, a regulation unit 30, and a reflection unit 40.

The projection unit 10 is configured to project a projection image. One end of the support frame 20 is fixed to the projection unit 10. The regulation unit 30 is suspended at the other end of the support frame 20, and configured to regulate a rotation angle. The reflection unit 40 is fixed to the regulation unit 30, and configured to reflect the projection image. The regulation unit 30 is configured to regulate a reflection direction of the reflection unit 40.

In an embodiment of the present disclosure, the projection unit 10 may be an aluminum alloy housing to facilitate heat dissipation. The projection unit 10 has a small device space and is very portable. The regulation unit 30 is capable of regulating the reflection direction of the reflection unit 40 in at least two different directions.

In summary, the projection apparatus 100 according to the embodiment of the present disclosure includes a projection unit 10, configured to project a projection image; a support frame 20, one end of the support frame 20 being fixed to the projection unit 10; a regulation unit 30, suspended at the other end of the support frame 20; and a reflection unit 40, fixed to the regulation unit 30, and configured to reflect the projection image. A reflection direction of the reflection unit 40 is regulated by regulating a rotation angle of the reflection unit 30, such that the reflection unit 40 reflects the projection image to a target projection position. The projection apparatus 100 according to the embodiment of the present disclosure is capable of conveniently regulating a projection direction.

In some embodiments, the regulation unit 30 includes: a first rotation assembly 31, and a second rotation assembly 32.

The first rotation assembly 31 is fixed to the other end of the support frame 20; and the second rotation assembly 32 is fixed to the first rotation assembly 31, wherein the reflection unit 40 is fixed to the second rotation assembly 32, the first rotation assembly 31 is configured to drive the second rotation assembly 32 to rotate in a first direction, and the second rotation assembly 32 is configured to drive the reflection unit 40 to rotate in a second direction, wherein the first direction is different from the second direction.

In an embodiment of the present disclosure, the first direction in a yaw angle, and the second direction is a pitch angle. In some other embodiments, the first direction and the second direction may be two directions perpendicular to each other, or two directions that are not perpendicular to each other but different from each other, and may be set according to actual needs, which is not limited to the description in the embodiments of the present disclosure.

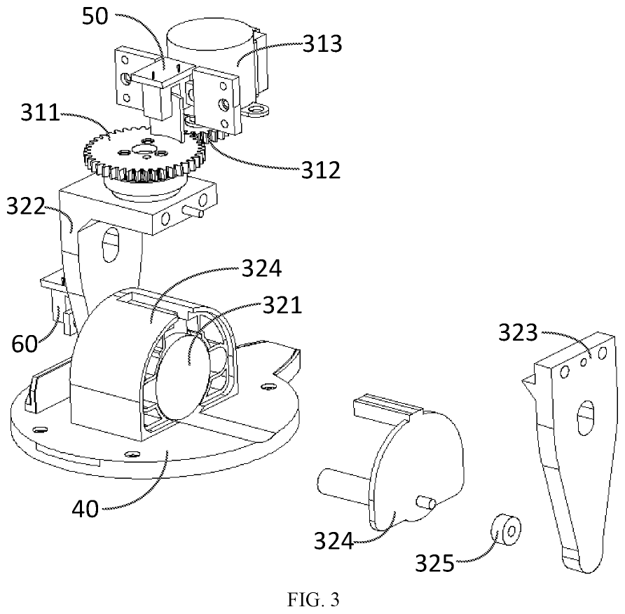

In some embodiments, referring to FIG. 3, an exploded view of the regulation unit 30 and the reflection unit 40 in the projection apparatus 100 in FIG. 1 is illustrated.

The first rotation assembly 31 includes a driven gear 311, a driving gear 312, and a first motor 313; the driven gear 311 is fixed to the second rotation assembly 32, the first motor 313 is fixed to the support frame 20, a rotation shaft of the first motor 313 is fixed to the driving gear 312, and the driving gear 312 is in mesh with the driven gear 311.

In an embodiment of the present disclosure, the driven gear 311, that is, the illustrated large gear, and the driving gear 312, that is, the illustrated small gear, form a gear reduction box. The first motor 313 drives the gear reduction box, such that the second rotation assembly 32 fixed to the driven gear 311 rotates about a central axis of the driven gear 311.

The second rotation assembly 32 includes: a second motor 321 and a first support arm 322; wherein the first support arm 322 is rotatably connected to the support frame 20, the driven gear 311 is fixed to the first support arm 322, a housing of the second motor 321 is fixed to the reflection unit 40, and a rotation shaft of the second motor 321 is fixed to the first support arm 322.

In an embodiment of the present disclosure, the first motor 313 and the second motor 321 are both a step motor. The reflection unit 40 is a reflection mirror. The projection apparatus 100 further includes a microcontroller unit (not illustrated), wherein the microcontroller unit is connected to the regulation unit 30, and is configured to control the regulation unit 30 to rotate. The first motor 313 and the second motor 321 are also each provided with a motor winder to prevent the wire twisting in the case that the regulation unit 30 rotates.

In some embodiments, the second rotation assembly 32 further includes a second support arm 323; wherein one end of the second support arm 323 is fixed to the first support arm 322, and the other end of the second support arm 323 is rotatably connected to the housing of the second motor 321. The second support arm 323 and the first support arm 322 may be, as illustrated in FIG. 3, two detachable parts, or may be integrally machined in one mold, and the second support arm 323 is rotatably connected to the second motor 321 via a bearing 325.

In some embodiments, the second rotation assembly 32 includes a motor fixing frame 324; wherein the reflection unit 40 is fixed to the motor fixing frame 324, the second motor 321 is fixed inside the motor fixing frame 324, the rotation shaft of the second motor 321 is extended out of the motor fixing frame 324, and the motor fixing frame 324 is rotatably connected to the other end of the second support arm 323.

In an embodiment of the present disclosure, the second motor 321 rotates to drive the first support arm 322 fixedly connected to the rotation shaft thereof, the motor fixing frame 324 configured to fix the second motor 321, and the reflection unit 40 fixed to the motor fixing frame 324 to rotate in the second direction. The rotation angle of the projection apparatus 100 in the second direction is in the range of 0 to 80 degrees.

In some embodiments, the projection apparatus 100 further includes: a first position sensor 50, and a second position sensor 60, wherein the first position sensor 50 is fixed to the first motor 313, and the second position sensor 60 is fixed to the first support arm 322.

In an embodiment of the present disclosure, the first position sensor 50 and the second position sensor 60 are angular displacement sensors, and further, may be capacitive sensors with high sensitivity to measure variations of angular displacement amounts of the first rotation assembly 31 and the second rotation assembly 32, which are sensing devices capable of converting the measured angular displacement caused by rotation of the rotation shaft into an electric signal based on a capacitance variation.

In the projection apparatus according to the embodiment of the disclosure, by arranging the regulation unit, specifically, by arranging the first rotation assembly and the second rotation assembly, multi-angle flexible regulation of a reflection unit is achieved, and the projection image and a projection light source are reflected to a projection area or a target projection position by the reflection unit in a large range.

In summary, the embodiment of the present disclosure provides a projection apparatus. The projection apparatus includes a projection unit, configured to project a projection image; a support frame, one end of the support frame being fixed to the projection unit; a regulation unit, suspended at the other end of the support frame; and a reflection unit, fixed to the regulation unit, and configured to reflect the projection image. A reflection direction of the reflection unit is regulated by regulating a rotation angle of the reflection unit, such that the reflection unit reflects the projection image to a target projection position. The projection apparatus according to the embodiment of the present disclosure is capable of conveniently regulating a projection direction.

It should be noted that the above described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objectives of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A projection apparatus, comprising:
a projection unit, configured to project a projection image;
a support frame, one end of the support frame being fixed to the projection unit;
a regulation unit, suspended at the other end of the support frame, and configured to regulate a rotation angle; and
a reflection unit, fixed to the regulation unit, and configured to reflect the projection image, wherein the regulation unit is configured to regulate a reflection direction of the reflection unit.

2. The apparatus according to claim 1, wherein the regulation unit comprises:
a first rotation assembly, fixed to the other end of the support frame; and
a second rotation assembly, fixed to the first rotation assembly, wherein the reflection unit is fixed to the second rotation assembly, the first rotation assembly is configured to drive the second rotation assembly to rotate in a first direction, and the second rotation assembly is configured to drive the reflection unit to rotate in a second direction, the first direction being different from the second direction.

3. The apparatus according to claim 2, wherein the first rotation assembly comprises: a driven gear, a driving gear, and a first motor;
wherein the driven gear is fixed to the second rotation assembly, the first motor is fixed to the support frame, a rotation shaft of the first motor is fixed to the driving gear, and the driving gear is in mesh with the driven gear.

4. The apparatus according to claim 3, wherein the second rotation assembly comprises: a second motor and a first support arm;
wherein the first support arm is rotatably connected to the support frame, the driven gear is fixed to the first support arm, a housing of the second motor is fixed to the reflection unit, and a rotation shaft of the second motor is fixed to the first support arm.

5. The apparatus according to claim 4, wherein the second rotation assembly further comprises:
a second support arm;
wherein one end of the second support arm is fixed to the first support arm, and the other end of the second support arm is rotatably connected to the housing of the second motor.

6. The apparatus according to claim 5, wherein the second rotation assembly comprises: a motor fixing frame;
wherein the reflection unit is fixed to the motor fixing frame, the second motor is fixed inside the motor fixing frame, the rotation shaft of the second motor is extended out of the motor fixing frame, and the motor fixing frame is rotatably connected to the other end of the second support arm.

7. The apparatus according to claim 6, wherein the first motor and the second motor are both a step motor.

8. The apparatus according to claim 4, further comprising:
a first position sensor, fixed to the first motor; and
a second position sensor, fixed to the first support arm.

9. The apparatus according to claim 1, wherein the reflection unit is a reflection mirror.

10. The apparatus according to claim 1, further comprising: a microcontroller unit;
wherein the microcontroller unit is connected to the regulation unit, and is configured to control the regulation unit to rotate.
